(19) United States
(12) Patent Application Publication
(10) Pub. No.: US 2012/0230672 A1
(43) Pub. Date: Sep. 13, 2012

(54) OPTICAL NETWORK ELEMENT

(75) Inventor: Erich Gottwald, Holzkirchen (DE)

(73) Assignee: NOKIA SIEMENS NETWORKS OY, ESPOO (FI)

(21) Appl. No.: 13/508,439

(22) PCT Filed: Nov. 5, 2009
(86) PCT No.: PCT/EP2009/064683

§ 371 Date: May 31, 2012

(51) Int. Cl. H04J 14/02

(52) U.S. Cl. 398/7

(57) ABSTRACT

An optical network element is provided and contains a tunable laser source and a resonator coupled with the tunable laser source. The resonator has a length that determines a distance between modes of the tunable laser source and failures during a mode transition time between modes of the tunable laser source are correctable via error correction measures. Furthermore, a communication system contains such an optical network element.

The invention relates to an optical network element, a communication system comprising at least one such optical network element and to a method for processing data in an optical network element.

A passive optical network (PON) is a promising approach regarding fiber-to-the-home (FTTH), fiber-to-the-business (FTTB) and fiber-to-the-curb (FTTC) scenarios, in particular as it overcomes the economic limitations of traditional point-to-point solutions.

The PON has been standardized and it is currently being deployed by network service providers worldwide. Conventional PONs distribute downstream traffic from the optical line terminal (OLT) to optical network units (ONUs) in a broadcast manner while the ONUs send upstream data packets multiplexed in time to the OLT. Hence, communication among the ONUs needs to be conveyed through the OLT involving electronic processing such as buffering and/or scheduling, which results in latency and degrades the throughput of the network.

In fiber-optic communications, wavelength-division multiplexing (WDM) is a technology which multiplexes multiple optical carrier signals on a single optical fiber by using different wavelengths (colors) of laser light to carry different signals. This allows for a multiplication in capacity, in addition to enabling bidirectional communications over one strand of fiber.

WDM systems are divided into different wavelength patterns, conventional or coarse and dense WDM. WDM systems provide, e.g., up to 16 channels in the 3rd transmission window (C-band) of silica fibers of around 1550 nm. Dense WDM uses the same transmission window but with denser channel spacing. Channel plans vary, but a typical system may use 40 channels at 100 GHz spacing or 80 channels at 50 GHz spacing. Some technologies are capable of 25 GHz spacing. Amplification options enable the extension of the usable wavelengths to the L-band, more or less doubling these numbers.

Optical access networks, e.g., a coherent Ultra-Dense Wavelength Division Multiplex (UDWDM) network, are deemed to be the future data access technology.

Within the UDWDM concept, potentially all wavelengths are routed to each ONU. The respective wavelength is selected by the tuning of the local oscillator (LO) laser at the ONU.

Upstream signals may be combined by using a multiple access protocol, e.g., invariable time division multiple access (TDMA). The OLTs “range” the ONUs in order to provide time slot assignments for upstream communication. Hence, an available data rate is distributed among many subscribers. Therefore, each ONU needs to be capable of processing much higher than average data rates. Such an implementation of an ONU is complex and costly.

In order to provide a more cost efficient approach, for the purpose of coherent detection, the ONU may be equipped with a less complex and inexpensive local oscillator laser that is tunable over a wide wavelength range, e.g., the C-band (>4 THz scanning range). However, such less complex tunable lasers with external tunable feedback bear the disadvantage of mode-hops, e.g. due to temperature variation.

The problem to be solved is to provide a cost-efficient tunable laser source that can be utilized in coherent PONs or optical access networks, in particular in an ONU.

This problem is solved according to the features of the independent claims. Further embodiments result from the depending claims.

In order to overcome this problem, an optical network element is provided comprising
a tunable laser source,
a resonator coupled with the tunable laser source, wherein the resonator has a length that determines a distance between modes of the tunable laser source, wherein failures during a mode transition time between modes of the tunable laser source are correctable via error correction means.

It is noted that such error correction means may be deployed with a receiver of this optical network element or with another optical network element. The optical network element mentioned substantially provides signals that could be corrected by such error correction means in case a mode-hop occurs.

Hence, the approach provided allows for a flexible and cost effective optical PON or optical access network. This is in particular useful in the area of UDWDM optical access networks utilizing coherent transmission and virtual point-to-point links.

Therefore, the tunable laser source is cost-efficient and provides a narrow optical range comprising several modes of operation.

It is noted that the tunable laser source may provide a linewidth in the order below 100 kHz, wherein several modes may have a spacing amounting to about 1 MHz (or a few megahertz). The modes may range over several tens of megahertz.

In another embodiment, the resonator comprises an external resonator.

Hence, the tunable laser source may be coupled with the resonator that is arranged within a tunable laser and/or it may be coupled with a resonator that is external to the tunable laser unit. An additional resonator length, increases the number of modes per frequency range.

In a further embodiment, the resonator comprises a fiber resonator. Such fiber resonator may have a length between 1 cm and 10 m.

In a next embodiment, the tunable laser source comprises at least one of the following:
a laser;
a distributed feedback (DFB) laser,
a distributed back-reflection (DBR) laser,
an external cavity laser (ECL).

It is also an embodiment that the tunable laser source is used as a local oscillator of the optical network element.

Pursuant to another embodiment, the tunable laser source is used as a transmitter of the optical network element.

According to an embodiment, a lifetime of a mode is significantly larger than a transition time between modes.

Hence, any data errors that may occur during such transition between modes of the tunable laser source can be compensated by the (forward) error correction means.

According to another embodiment, the lifetime of a mode is about 1000 times larger than the transition time between modes.

In yet another embodiment, the tunable laser source is arranged with a back-reflection means.

Such back-reflection means is provided to obtain a narrow spacing between modes of the tunable laser source.

The problem stated supra is further solved by a communication system comprising the device as described herein.

The problem stated above is also solved by a method for processing data in an optical network,
wherein data is conveyed via a tunable laser source associated with a resonator with a length that results in a distance between modes of the tunable laser source,
wherein a failure during a mode transition time between modes of the tunable laser source are corrected by error correction means.

According to an embodiment, the lifetime of a mode is significantly larger than a transition time between modes of the tunable laser source.

Pursuant to yet an embodiment, the lifetime of a mode is about 1000 times larger than the transition time between modes.

Embodiments of the invention are shown and illustrated in the following figures:

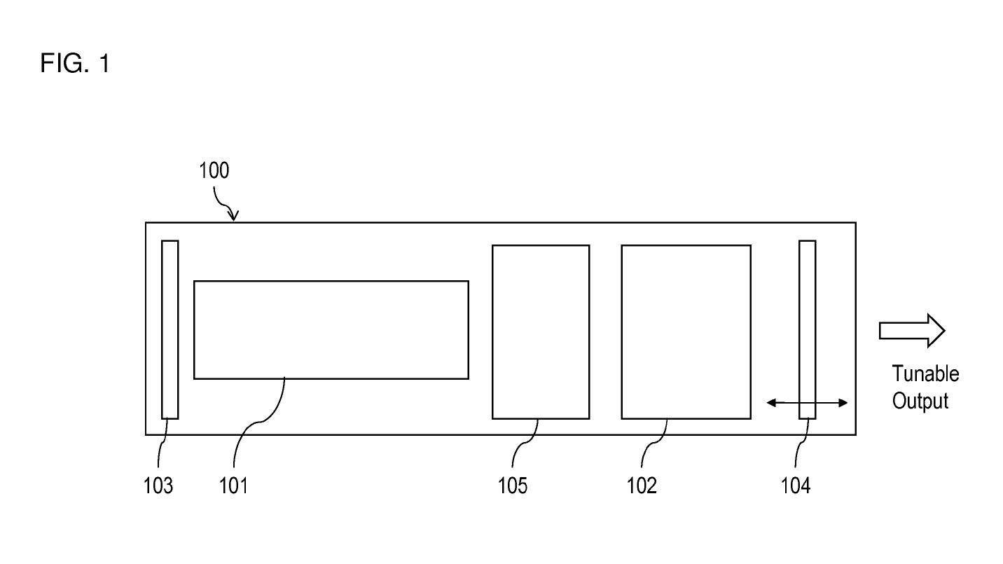

FIG. 1 shows a schematic of a generic tunable single-frequency laser comprising a gain element, a mode-selection filter, a phase shifter and two mirrors;

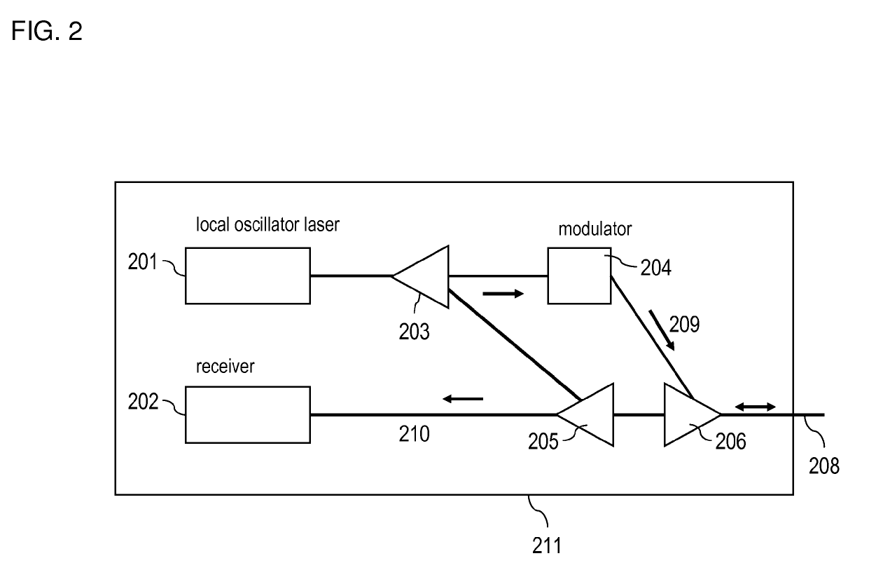

FIG. 2 shows an arrangement comprising a local oscillator laser, splitters, a modulator and a receiver, wherein such components could be part of an ONU;

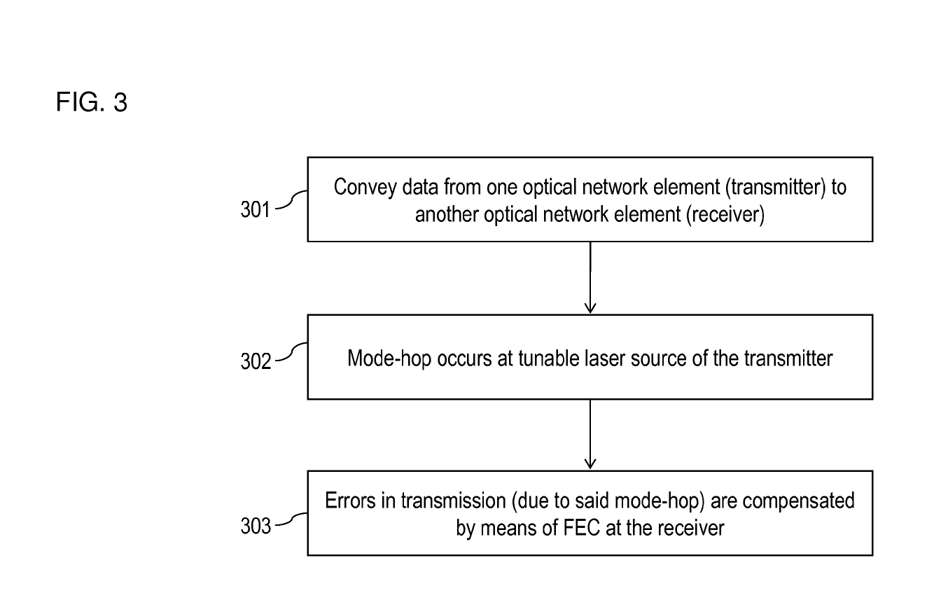

FIG. 3 shows steps of a method of processing data in an optical network.

Hence, the current approach in particular suggests an economical single-mode narrow linewidth tunable laser as a local oscillator and/or as a laser source transmitter by using a multi mode narrow linewidth tunable laser and a receiver with forward error correction (FEC) means.

It is noted that the multimode laser may provide a narrow linewidth; the laser may operate at a first mode, then a mode-hop may occur to another mode. The mode-hop itself lasts for a considerably short time period, which is significantly shorter than a stable mode condition in which the laser emits light with a narrow linewidth.

Hence, the laser source may be a multi mode laser comprising several modes with short-time mode-hops. The average lifetime of a mode may be in the order of several milliseconds.

The current proposal in particular uses a differential phase modulation or amplitude modulation format with incoherent detection in the electrical domain and a tunable laser source together with a back reflection means that results in a narrow linewidth. The laser source may be tunable by at least one tunable filter and/or at least one mirror.

An additional resonator could be provided with the laser source and does not have to be stabilized and phase matched to the long resonator determining a mode spacing in the range of a few megahertz. If the coupling of the additional resonator (which could be a long external resonator) is strong enough, a linewidth may amount to less than 100 kHz. Hence, the linewidth of the laser at a state of an immediately impending mode-hop is less than the maximum tolerable linewidth of the system.

The resonator can at least partially be realized as a fiber resonator with a length in a range, e.g., between 1 cm and 10 m. The laser source can be a tunable laser, e.g., a distributed feedback (DFB) laser, a distributed back-reflection (DBR) laser or an external cavity laser (ECL).

It is also an option to provide a fiber laser design with a tunable external grating reflector for a mode-selection filter and in particular without any special measures for phase stabilization purposes.

In all embodiments, the long cavity mode spacing may lead to a linewidth spacing that is below a tolerable frequency inaccurateness. Hence, due to forward error correction (FEC), the errors occurring at a transition between mode-hops (the laser source jumping from a point of single mode operation to another) can be compensated to a given extent (in particular totally compensated). The linewidth spacing of the modes may have to be dimensioned such that FEC is able to correct data errors due to mode-hops.

For example, a transition time from one mode to the next mode can be in the range below microseconds. A mode may last for about 10 milliseconds, this may result in a bit error floor of less than 0.0001, which can be corrected by FEC. Advantageously, a ratio between an average mode life-time and the transition time may exceed 1000.

It is a further advantage that there is no need for a particular stabilization of the external cavity with respect to phase matching and/or temporal phase stability. The linewidth spacing required can be provided via the extended length of the external resonator, the average wavelength of the laser source is adjusted via the tunable filter and/or mirror.

The mode-hops caused, e.g., by time varying phase mismatch may be the result of temporal temperature fluctuations or mechanical vibrations and—according to the approach presented—do not require special measures. This results in cost-efficient lasers that can be deployed with optical network elements like ONUS or OLTs.

FIG. 1 shows a schematic of a tunable laser 100 comprising a gain element 101, a mode-selection filter 102, a phase shifter 105 and two mirrors 103, 104. The mode-selection filter 102 allows frequency tuning of the laser. According to the approach presented, no phase adjustment is required at the phase shifter in case the mode spacing is significantly smaller than the tolerable frequency misalignment.

The gain element 101 could be an internal resonator of the laser 100. In addition to this internal resonator, an external resonator could be provided in order to reduce the spacing between modes of the tunable laser. Such external resonator could be a fiber resonator of a length between 1 cm and 10 m.

FIG. 2 shows an arrangement comprising a local oscillator laser 201, splitters 203, 205 and 206, a modulator 204 and a receiver 202. These components may be part of an ONU 211. An optical fiber 208 may be connected towards an OLT (not shown).

The signal generated at the local oscillator laser 201 is modulated via the modulator 204 to produce an upstream data signal 209 to be conveyed via the optical fiber 208. An incoming optical signal via fiber 208 is fed to the receiver 202. Also the signal generated at the local oscillator laser 201 is fed via splitters 203 and 205 to the receiver 202. Hence, the local oscillator laser 201 is used for modulation purposes to transmit the signal from the ONU 211 to the OLT and for reception purposes regarding the incoming received signal 210. For the latter purpose, the wavelength of the local oscillator laser 201 needs to be adjusted to the wavelength of the incoming signal. The approach described herein allows for an accelerated scanning process in order to detect the lock onto the incoming signal within a short period of time.

FIG. 3 shows steps of a method of processing data in an optical network. In a step 301 data is conveyed from one optical network element, a transmitter, to another optical network element, a receiver. Such transmission is achieved via a tunable laser source used for modulation purposes as explained in FIG. 2. A mode-hop occurs during the transmission (see step 302). The mode-hop may result in data errors that can be compensated by the receiver utilizing forward error correction means. Hence, the mode-hops of the tunable laser source at the transmitter are not critical and can be tolerated. This allows utilizing cost-efficient laser in optical network elements, e.g., ONUs or OLTs, without any need for additional and costly compensation means.

### List of Abbreviations:

### FEC Forward Error Correction

### OAN Optical Access Network

### OLT Optical Line Terminal

### ONU Optical Network Unit

### PON Passive Optical Network

### UDWDM Ultra-Dense WDM

WDM Wavelength Division Multiplex

1-15. (canceled)

16. An optical network element, comprising:
a tunable laser source; and
a resonator coupled with said tunable laser source, said resonator having a length for determining a distance between modes of said tunable laser source, wherein failures during a mode transition time between the modes of said tunable laser source are correctable via error correction means.

17. The device according to claim 16, wherein a linewidth of said tunable laser source amounts to less than 100 kHz.

18. The device according to claim 16, wherein said resonator has an external resonator.

19. The device according to claim 16, wherein said resonator contains a fiber resonator.

20. The device according to claim 19, wherein said fiber resonator has a length between 1 cm and 10 m.

21. The device according to claim 16, wherein said tunable laser source contains at least one of the following:
a laser;
a distributed feedback laser;
a distributed back-reflection laser; and
an external cavity laser.

22. The device according to claim 16, wherein said tunable laser source functions as a local oscillator of the optical network element.

23. The device according to claim 16, wherein said tunable laser source functions as a transmitter of the optical network element.

24. The device according to claim 16, wherein a lifetime of a mode is significantly larger than the mode transition time between the modes.

25. The device according to claim 24, wherein the lifetime of the mode is about 1000 times larger than the mode transition time between the modes.

26. The device according to claim 16, wherein said tunable laser source has back-reflection means.

27. A communication system, comprising:
an optical network element containing a tunable laser source and a resonator coupled with said tunable laser source, said resonator having a length for determining a distance between modes of said tunable laser source, wherein failures during a mode transition time between the modes of said tunable laser source are correctable via error correction means.

28. A method for processing data in an optical network, which comprises the steps of:
conveying data via a tunable laser source associated with a resonator with a length that results in a distance between modes of the tunable laser source; and
correcting failures during a mode transition time between the modes of the tunable laser source by error correction means.

29. The method according to claim 28, wherein a lifetime of a mode is significantly larger than the mode transition time between the modes.
